(19) United States
(12) Patent Application Publication
(10) Pub. No.: US 2012/0170841 A1
(43) Pub. Date: Jul. 5, 2012

(54) IMAGE PROCESSING APPARATUS AND METHOD

(75) Inventors: Seung Sin LEE, Yongin-si (KR); Seok LEE, Hwaseong-si (KR); Jae Joon LEE, Seoul (KR); Ho Cheon WEY, Seongnam-si (KR)

(73) Assignee: SAMSUNG ELECTRONICS CO., LTD., Suwon-si (KR)

(21) Appl. No.: 13/343,370

(22) Filed: Jan. 4, 2012

(30) Foreign Application Priority Data
Jan. 5, 2011 (KR) 10-2011-0000999
Apr. 29, 2011 (KR) 10-2011-0040768

(51) Int. Cl. G06K 9/36

(52) U.S. Cl. 382/166

(57) ABSTRACT

A view transformer of an image processing apparatus may generate a first view transformation image by transforming a first view color image with a first resolution to a third view, and may generate a second view transformation image by transforming, to the third view, a second view color image with a second resolution higher than the first resolution. A parameter calculator of the image processing apparatus may calculate a per-pixel weight parameter that is applied to each of the first view transformation image and the second view transformation image. An image generator of the image processing apparatus may generate a third view color image corresponding to the third view by applying the calculated per-pixel weight parameter to the first view transformation image and the second view transformation image.

### CROSS-REFERENCE TO RELATED APPLICATIONS

This application claims the priority benefit of Korean Patent Application No. 10-2011-0000999, filed on Jan. 5, 2011, and Korean Patent Application No. 10-2011-0040768, filed on Apr. 29, 2011, in the Korean Intellectual Property Office, the disclosures of which are incorporated herein by reference.

### BACKGROUND

1. Field

One or more embodiments relate to an image processing apparatus and method for providing a three-dimensional (3D) image, and more particularly, to an apparatus and method for generating an image corresponding to a predetermined view in an autostereoscopic 3D display.

2. Description of the Related Art

A glass type stereoscopic display being generally applied in a three-dimensional (3D) image service requires the user to endure the inconvenience of wearing glasses and also has many constraints. For example, there are constraints in a view area due to the use of only a single pair of left and right images, or motion parallax.

Research on a multi-view display enabling a configuration at multiple views using a plurality of images and without using glasses has been actively conducted. In addition, standardization on compression and a format for a multi-view image, for example, motion picture experts group (MPEG) 3DV, has been ongoing.

In the above multi-view image scheme, images observed at a plurality of views may need to be transmitted. A method of transmitting the entire set of 3D images observed at all views may use a significant amount of bandwidth and, thus, may not be readily realized.

Accordingly, there is a desire for a method that may transmit a predetermined number of view images and side information such as depth information and/or disparity information, and may generate and display a plurality of view images used by a reception apparatus.

### SUMMARY

Aspects of the current invention provide a method and apparatus to use a low resolution first image with a first view of a scene and a high resolution second image with a second view of the same scene to generate a high resolution third image with a third view of the same scene.

The foregoing and/or other aspects are achieved by providing an image processing apparatus including a view transformer to generate a first view transformation image by transforming a first view color image with a first resolution to a third view, and to generate a second view transformation image by transforming, to the third view, a second view color image with a second resolution higher than the first resolution, a parameter calculator to calculate a per-pixel weight parameter that is applied to each of the first view transformation image and the second view transformation image, and an image generator to generate a third view color image corresponding to the third view by applying the calculated per-pixel weight parameter to the first view transformation image and the second view transformation image.

The image processing apparatus may further include a high frequency component extractor to extract, in the second view transformation image, an area where a high frequency component is present. In this example, the parameter calculator may calculate the per-pixel weight parameter of the second view color image to be relatively high with respect to the extracted area compared to other areas.

The parameter calculator may calculate the per-pixel weight parameter of the second view transformation image to be relatively high proportional to a frequency of extracted high frequency component.

The parameter calculator may calculate a first view distance weight parameter that is inversely proportional to a distance between the first view and the third view, and a second view distance weight parameter that is inversely proportional to a distance between the second view and the third view.

The image generator may generate the third view color image by applying the per-pixel weight parameter and the first view distance weight parameter to the first view transformation image, and by applying the per-pixel weight parameter and the second view distance weight parameter to the second view transformation image.

The parameter calculator may apply, to the first view transformation image based on a frequency of the high frequency component, a high pass filter that passes a frequency greater than or equal to a predetermined frequency without attenuation.

The parameter calculator may apply the high pass filter to a pixel of the first transformation image corresponding to a position at which the high frequency component is extracted in the second view transformation image.

The image generator may generate the third view color image by applying the per-pixel weight parameter, a first view distance weight parameter, and the high pass filter to the first view transformation image, and by applying the per-pixel weight parameter and a second view distance weight parameter to the second view transformation image.

The view transformer may generate the first view transformation image and the second view transformation image by performing image warping according to a position of the third view with respect to the first view color image and the second view color image based on depth information of a first view depth image corresponding to the first view color image and depth information of a second view depth image corresponding to the second view color image.

The image generator may generate the third view color image by applying the per-pixel weight parameter to the first view transformation image and the second view transformation image, and by calculating a linear sum for each pixel. The third view color image may have the second resolution.

The foregoing and/or other aspects are achieved by providing an image processing method including generating a first view transformation image by transforming a first view color image with a first resolution to a third view, and generating a second view transformation image by transforming, to the third view, a second view color image with a second resolution higher than the first resolution, calculating a per-pixel weight parameter that is applied to each of the first view transformation image and the second view transformation image, and generating a third view color image corresponding to the third view by applying the calculated per-pixel weight parameter to the first view transformation image and the second view transformation image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to one or more embodiments;

FIG. 2 illustrates a diagram to describe a multi-view image transmitted from an image processing apparatus according to one or more embodiments;

FIG. 3 illustrates a first view image of a low resolution and a second view image of a high resolution according to one or more embodiments;

FIG. 4 illustrates a result of a high frequency component extracted from a second view image of a high resolution according to one or more embodiments;

FIG. 5 illustrates pixels of an image generated by transforming a second view image to a third view according to one or more embodiments;

FIG. 6 illustrates pixels of an image generated by transforming a first view image to a third view according to one or more embodiments;

FIG. 7 illustrates a third view image generated according to one or more embodiments;

and

FIG. 8 illustrates an image processing method according to one or more embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

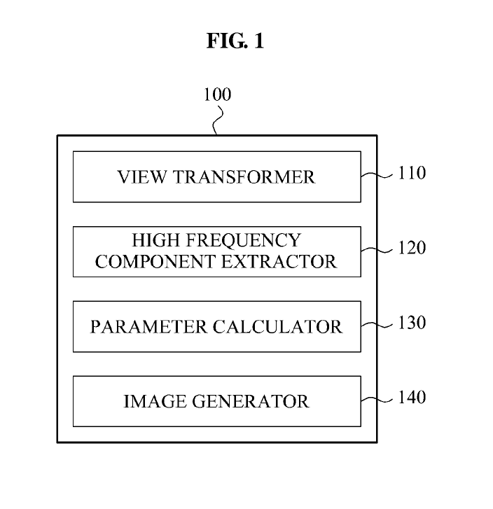

FIG. 1 illustrates an image processing apparatus 100 according to one or more embodiments.

Multi-view images corresponding to a plurality of views may be input to the image processing apparatus 100.

Each view image of the multi-view images input to the image processing apparatus 100 may include a pair of a color image and a depth image. This format may be referred to as a multiple video and depth (MVD) three-dimensional (3D) video format.

In general, since the MVD 3D video format includes a plurality of color images and a plurality of depth images that have the same resolution, a size of an image to be transmitted or a required bandwidth may be proportional to a number of views or a resolution.

When multi-view images having a relatively large number of views are transmitted, the required bandwidth may also increase. As a resolution of each of view images increases, the required bandwidth may also increase.

Accordingly, even though the relatively large number of views of multi-view images and the relatively high resolution of each of view images may need to be set to provide a 3D image with reality and good quality, there may be some constraints due to a communication bandwidth or a data size.

By decreasing a resolution of some view images among a plurality of view images constituting the multi-view images, some view images may be configured to have a lower resolution, such as a fourth of a resolution, for example, compared to a resolution of other view images.

Compressing the multi-view images so that some views may have a relatively high resolution and other views may have a relatively low resolution, and transmitting the compressed image may be expressed by a mixed resolution scheme. Embodiments may be related to an image processing method of synthesizing images captured at a plurality of views using the transmitted multi-view images according to the mixed resolution scheme.

Hereinafter, in the multi-view images input to the image processing apparatus 100, some view images may have a first resolution and other view images may have a second resolution higher than the first resolution.

For example, the first resolution may be 960×540 and the second resolution may be 1920×1080 corresponding to a full high definition (HD). The above resolutions are only examples and thus, embodiments are not limited to or restricted by a predetermined resolution.

In addition to an example in which only two resolutions are included, the mixed resolution scheme may be applicable to an example in which at least three resolutions are included, depending on embodiments. An embodiment using two resolutions is described below as an example.

According to one or more embodiments, there may be provided an image processing apparatus and method in which the image processing apparatus 100 that is a reception end may receive multi-view images that are transmitted using a mixed resolution scheme, and may generate a high resolution image at provided views and an additional predetermined view.

When multi-view images of an MVD 3D video format are received by the image processing apparatus 100 that is a reception end, the image processing apparatus 100 may generate an image at an additional predetermined view by synthesizing the multi-view images.

For example, even though the provided multi-view images correspond to 5-view images, multi-view images generated by the image processing apparatus 100 may have 33 views or more, for example.

A view transformer 110 may generate a first view transformation image by transforming, to a third view, a first view color image with a first resolution corresponding to a low resolution. The third view may correspond to a view that is not provided and corresponds to an image to be currently generated by the image processing apparatus 100.

The view transformation may correspond to a process of warping pixels of the first view color image to a position corresponding to the third view.

Since a color image and a depth image match, how much to shift the first view color image may be verified based on a view distance between the first view and the third view and a disparity according to depth information of a first view depth image corresponding to the first view color image.

The above process is referred to as image warping according to view transformation, which is known to those skilled in the art.

The view transformer 110 may generate a second view transformation image by transforming, to the third view, a second view color image with a second resolution corresponding to a high resolution.

The first view transformation image and the second view transformation image are images corresponding to the third view. However, since the first view transformation image has a low resolution and the second view transformation image has a high resolution, the resolutions may not match.

The first view and the second view may correspond to neighboring views of the third view at which a current image is to be generated. For example, when the first view corresponds to a left view of the third view, the second view may correspond to a right view of the third view.

Generating a third view image by transforming both the first view color image and the second view color image may be in order to correct an error that may occur in a view transformation process, for example, an image warping process, and to acquire a more natural-looking image.

Since the resolution of the first view color image is different from the resolution of the second view color image, the image processing apparatus 100 may scale-up the resolution of the first view transformation image to match the resolution of the second view for each pixel.

In this example, the second view transformation image originally has a high resolution, and the first view transformation image is scaled-up from a low resolution. Accordingly, in a portion where there is more precision, for example, in an edge portion, a pixel value of the second view transformation image may be more reliable than a pixel value of the first view transformation image.

To determine a pixel value of the portion where there is more precision, a high frequency component extractor 120 may extract, from pixels of the second view transformation image, pixels that have a high frequency component. Extracting pixels with the high frequency component may be performed to distinguish a portion having at least a predetermined frequency by performing frequency analysis of the second view transformation image.

The high frequency component extracting process may be to express a continuous or discrete frequency with respect to each of the pixels of the second view transformation image. In this example, the high frequency component extracting process may be classified into more grades of frequency levels.

A parameter calculator 130 may calculate a per-pixel weight parameter. In this example, the parameter calculator 130 may assign a relatively high weight to a pixel value of the second view transformation image with respect to a pixel that has a relatively high frequency in the frequency analysis of the second view transformation image, and may assign a lower weight to a pixel value of the first view transformation image and a pixel value of the second view transformation image with respect to a pixel that has a relatively low frequency.

The third view may be positioned in the middle of the first view and the second view or may be closer to one view between the first view and the second view. Since an image of a closer view is more reliable, the parameter calculator 130 may also calculate a view distance weight parameter that assigns a weight based on a distance between views.

The parameter calculator 130 may apply, to the first view transformation image based on a frequency of the high frequency component, a high pass filter that passes a frequency greater than or equal to a predetermined frequency without attenuation. For example, for resolution enhancement, the parameter calculator 130 may apply the high pass filter to a pixel of the first transformation image corresponding to a position at which the high frequency component is extracted in the second view transformation image.

An image generator 140 may calculate color values of pixels of the third view image by blending pixels of the scaled-up first view transformation image and the second view transformation image. In this process, the per-pixel weight parameter and the view distance weight parameter may be used. In addition, high pass filtering, for example, or other methods for resolution enhancement may be applied to pixels of the first view transformation image at a position where a frequency is high.

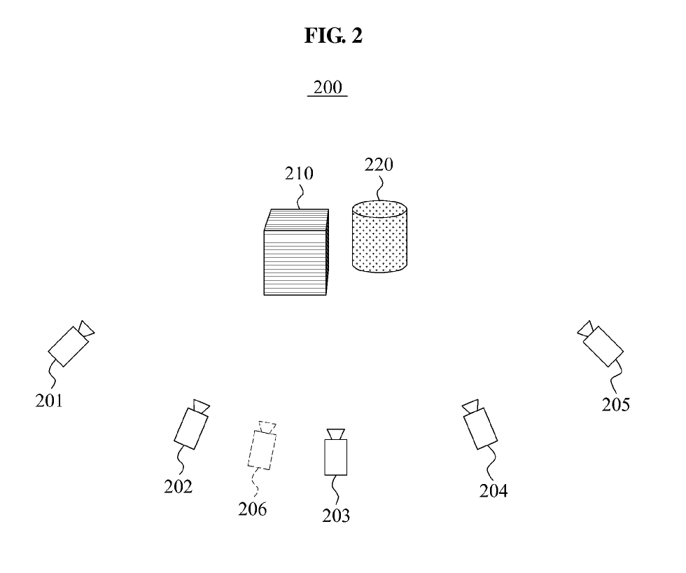

The above process will be further described with reference to FIG. 2.

FIG. 2 illustrates a diagram 200 to describe a multi-view image transmitted from the image processing apparatus 100 according to one or more embodiments.

An object 210 and an object 220 constituting a 3D model may be photographed or rendered at five views 201, 202, 203, 204, and 205.

Multi-view images of the five views 201, 202, 203, 204, and 205 may be transmitted using a mixed resolution scheme. For example, images observed at the views 201, 203, and 205 may correspond to images of a high resolution, and images observed at the views 202 and 204 may correspond to images of a low resolution.

Each view image may include a color image and a depth image.

The image processing apparatus 100 may generate a high resolution image at a predetermined view 206 through the process described above with reference to FIG. 1. It will be further described later.

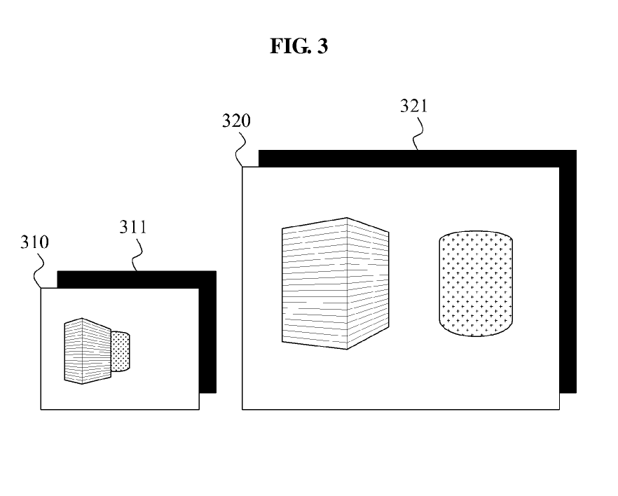

FIG. 3 illustrates a first view image of a low resolution and a second view image of a high resolution according to one or more embodiments. Hereinafter, for ease of description, among the views 201, 202, 203, 204, 205, and 206 of FIG. 2, the view 202 is referred to as a first view, the view 203 is referred to as a second view, and the view 206, corresponding to a virtual view, is referred to as a third view.

The first view image corresponding to the first view 202 may include a pair of a first view color image 310 and a first view depth image 311. The first view image may have a low resolution such as 950×540, for example.

The second view image corresponding to the second view 203 may include a pair of a second view color image 320 and a second view depth image 321. The second view image may have a high resolution such as 1920×1080, for example.

In each of the first view image and the second view image, depth images may have a resolution lower than corresponding color images. However, this aspect is not described here.

The view transformer 110 of the image processing apparatus 100 may perform a view transformation of the first view color image 310 to correspond to the third view 206, based on depth information acquired from the first view depth image 311 and a view distance between the first view 202 and the third view 206.

As described above with reference to FIG. 1, the view transformation may correspond to a general image warping process. The image warping process may include depth mapping, texture mapping, and/or hole filling, for example.

When the view transformation of the first view color image 310 is performed to correspond to the third view 206, a first view transformation image (not shown) may be generated. When a view transformation of the second color view image 320 is performed to correspond to the third view 206, a second view transformation image (not shown) may be generated.

The high frequency component extractor 120 of the image processing apparatus 100 may perform frequency analysis of the second view transformation image of a high resolution. Through the frequency analysis, the high frequency component extractor 120 may verify a portion with a high frequency that indicates an area where a high frequency component is present.

The portion with the high frequency component may be, for example, an edge area within the image, or an area where a texture or a color vary significantly.

When increasing, through a simple interpolation, a resolution of the first view transformation image corresponding to a low resolution to match a resolution of the second view transformation image corresponding to a high resolution, and blending the scaled-up first view transformation image and the second view transformation image, an undesired blur phenomenon may occur in the edge portion and the like due to the insufficient high frequency component of the first view transformation image.

Accordingly, in the portion with the high frequency component, there is a need to increase a weight of the second view transformation image corresponding to a high resolution.

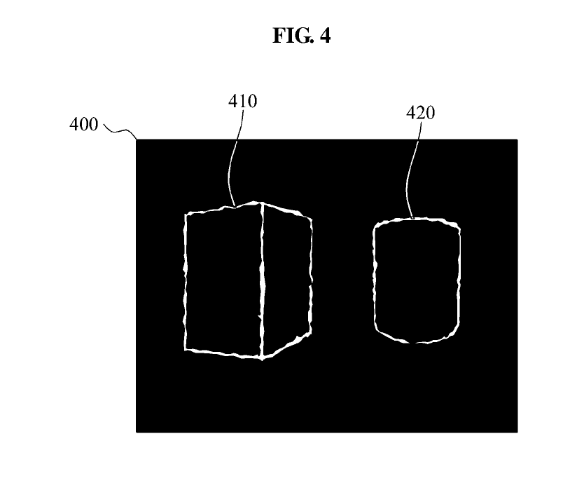

FIG. 4 illustrates a result of a high frequency component extracted from a second view image with a high resolution according to one or more embodiments.

A process of extracting a high frequency component from a second view depth image 400 with a high resolution may be an edge detection process using a general frequency analysis or an image processing algorithm, for example.

Referring to FIG. 4, areas 410 and 420 where a relatively high frequency is present are expressed with a bright color and other areas are expressed with a dark color.

A brightness difference according to the above frequency may have levels from a minimum of two levels to many levels, such as 256 or more levels, for example.

The parameter calculator 130 may calculate a per-pixel weight parameter by assigning a relatively high weight to a pixel value of the second view transformation image with respect to a pixel that has a relatively high frequency in the frequency analysis of the second view transformation image, and by assigning a lower weight to a pixel value of the first view transformation image and a pixel value of the second view transformation image with respect to a pixel that has a relatively low frequency.

In addition to the per-pixel weight parameter using the frequency analysis, the parameter calculator 130 may also calculate other parameters based on a view distance.

The third view 206 may be positioned in the middle of the first view 202 and the second view 203 or may be closer to one view between the first view 202 and the second view 203. Since an image of a closer view is more reliable, the parameter calculator 130 may also calculate a view distance weight parameter that assigns a weight based on a view distance.

The parameter calculator 130 may calculate a first view distance weight parameter that is inversely proportional to a distance between the first view 202 and the third view 206 and apply the first view distance weight parameter to the first view transformation image. The parameter calculator may calculate a second view distance weight parameter that is inversely proportional to a distance between the second view 203 and the third view 206 and apply the second view distance weight parameter to the second view transformation image.

At a high frequency component position of the second view transformation image, the parameter calculator 130 may apply high pass filtering and the like to a color value of a scaled-up pixel that is generated from the first view transformation image of the low resolution.

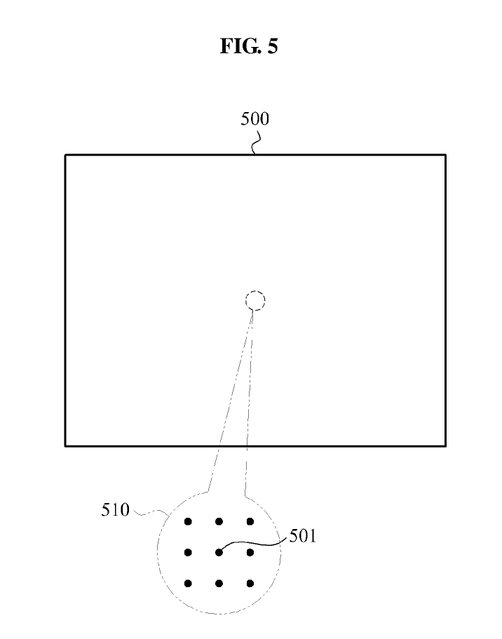

FIG. 5 illustrates pixels of a second view transformation image 500 generated by transforming a second view image to a third view according to one or more embodiments.

Referring to FIG. 5, pixels within an area 510 may be relatively dense compared to pixels within an area of a low resolution corresponding to the area 510. Accordingly, to calculate a color value of a third view image corresponding to a pixel 501 among the pixels within the area 510, the parameter calculator 130 may determine a per-pixel weight parameter to be assigned to the color value of the pixel 501 based on whether a frequency is high or low.

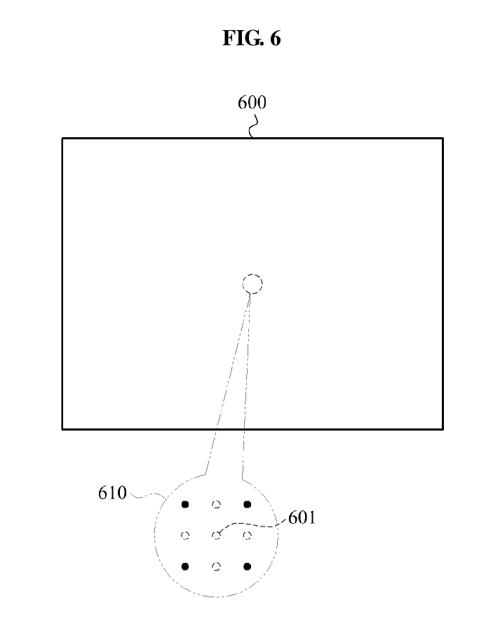

FIG. 6 illustrates pixels of a first view transformation image 600 generated by transforming a first view image to a third view according to one or more embodiments.

Since a resolution of the first view transformation image 600 corresponds to a relatively low resolution, pixels within an area 610 corresponding to the area 510 of FIG. 5 may be relatively sparse. In this instance, a pixel corresponding to the pixel 501 may be absent in the first view transformation image 600. Thus, a pixel 601 may be generated through interpolation. The above process may be understood as a scale-up of the first view transformation image 600.

To calculate a color value of the pixel 601 in the third view image corresponding to the pixel 501, a weight parameter to be assigned to a color value of the pixel 501 may be determined by the parameter calculator 130 based on whether the frequency of the pixel 501 is high or low.

The parameter calculator 130 may assign a weight of approximately 0.5 to each of the high resolution second view transformation image and the first view transformation image scaled-up from the low resolution with respect to a portion with a relatively low frequency.

With respect to a portion with a relatively high frequency, a relatively high weight may be assigned to the second view transformation image and a relatively low weight may be assigned to the first view transformation image.

Accordingly, with respect to a portion with a highest frequency, a weight of approximately ‘0’ may be assigned to the first view transformation image and a weight of approximately ‘1’ may be assigned to the second view transformation image.

The parameter calculator 130 may apply a high pass filter to all of the first view transformation image 600 or the color value of the pixel 601 that is up-scaled from the first view transformation image 600 of the low resolution, at a position of the first view transformation image 600 corresponding to a high frequency component position of the second view transformation image 500.

Through the above process, in a portion with a robust high frequency component, for example, an edge portion, a weight of a high resolution view image may increase, thereby increasing definition of a synthesized image using two view images. Accordingly, it is possible to enhance an image so that it appears more natural-looking. Also, a resolution of a view image having a low resolution may be enhanced due to the high pass filter.

The image generator 140 may generate a third view color image corresponding to the third view 206 based on determined parameters.

It may be assumed that X_{L} denotes the color value of the pixel 601 scaled-up and thereby generated from the first view transformation image 600 of the low resolution, and X_{R} denotes the color value of the pixel 501 positioned in the same position in the second view transformation image 500 as the pixel 601.

When a per-pixel weight parameter to be assigned to the pixel 501 of the second view transformation image 500 of the high resolution is W, the parameter calculator 130 may determine the per-pixel weight parameter W within the range of approximately 0.5 to approximately 1.0 to be proportional to the frequency of the pixel 501.

The image generator 140 may calculate a color value X_{V} of the same position pixel of the third view image according to Equation 1.

X_{V}=(1−W)X_{L}+WX_{R} [Equation 1]

The parameter calculator 130 may separately calculate a weight parameter that is inversely proportional to a view distance, based on a distance between each of the first view 202 and the second view 203, and the third view 206, and may use the calculated weight parameter.

For example, the parameter calculator 130 may calculate a view distance weight parameter a to be inversely proportional to a view distance between the second view 203 and the third view 206, and the image generator 140 may calculate X_{V} according to Equation 2, by applying the view distance weight parameter a to Equation 1.

X_{V}=(1−α)(1−W)X_{L}+αWX_{R} [Equation 2]

According to one or more embodiments, as expressed by Equation 3, a high pass filter may be applied to the color value X_{L} of the pixel 601 that is scaled-up from the first view transformation image 600 of the low resolution, at the high frequency component position of the second view transformation image 500.

X_{V}=(1−α)(1−W)H[X_{L}]+αWX_{R} [Equation 3]

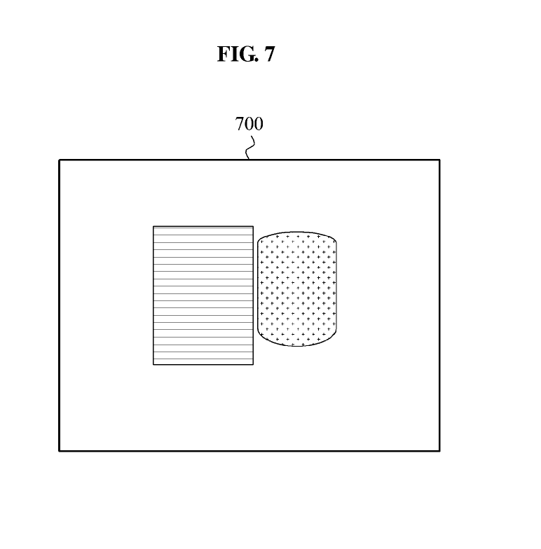

FIG. 7 illustrates a third view image 700 generated according to one or more embodiments.

Even though a multi-view image is not directly provided to the image processing apparatus 100, the third view image 700 may be generated through the above process. Since images of the first view 202 and the second view 203 are used, an error according to image warping may be minimized and thus, the third view image 700 may appear more natural-looking.

Using a mixed resolution scheme, the second view image of the high resolution may appear to be relatively large in an edge portion with a high frequency component, and blending may be performed based on a view distance in other portions and thus, definition of an image may also increase.

Since a high pass filter is applied to a resolution of a view transformation image having a low resolution whereby the resolution of the view transformation image may be enhanced, definition of an image may increase.

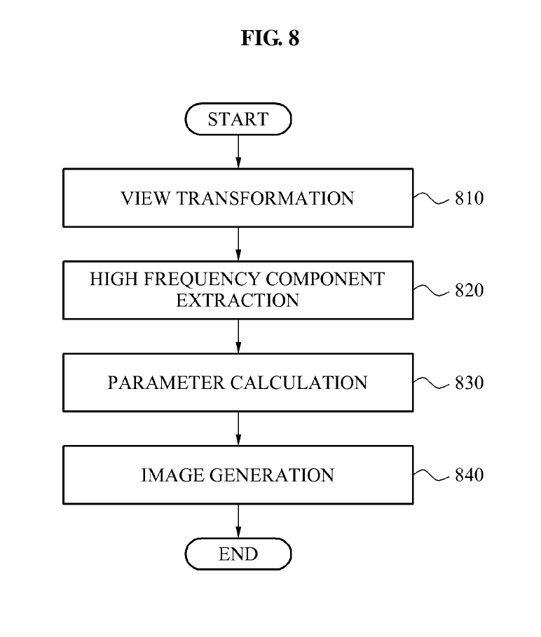

FIG. 8 illustrates an image processing method according to one or more embodiments.

In operation 810, the view transformer 110 may generate a first view transformation image by transforming, to a third view, a first view image with a provided first resolution corresponding to a low resolution. The view transformation may correspond to a process of warping pixels of the first view color image to a position corresponding to the third view. The view transformer 110 may generate a second view transformation image by transforming, to the third view, a second view color image with a second resolution corresponding to a high resolution.

The view transformation process is described above with reference to FIG. 1 through FIG. 3 and thus, further detailed description will be omitted here.

In operation 820, the high frequency component extractor 120 may extract, from pixels of the second view transformation image, pixels that have a high frequency component. Extraction of the pixels with the high frequency component may be performed to distinguish a portion having at least a predetermined frequency by performing frequency analysis of the second view transformation image.

The high frequency extracting process is described above with reference to FIG. 4 and thus, further detailed description will be omitted here.

In operation 830, the parameter calculator 130 may calculate a per-pixel weight parameter. In this example, the parameter calculator 130 may assign a relatively high weight to a pixel value of the second view transformation image with respect to a pixel that has a relatively high frequency in the frequency analysis of the second view transformation image, and may assign a lower weight to a pixel value of the first view transformation image and a pixel value of the second view transformation image with respect to a pixel that has a relatively low frequency.

The third view may be positioned in the middle of the first view and the second view, or may be closer to one view between the first view and the second view. Since an image of a closer view is more reliable, the parameter calculator 130 may also calculate a view distance weight parameter.

To generate clearer third view image, the parameter calculator 130 may apply a high pass filter to a pixel value of a position corresponding to a high frequency component position of the first view transformation image or the second view transformation image of the low resolution.

In operation 840, the image generator 140 may calculate color values of pixels of the third view image by blending pixels of the scaled-up first view transformation image and the second view transformation image. In this process, the per-pixel weight parameter and the view distance weight parameter may be used.

The image generating process is described above with reference to FIG. 5 through FIG. 7.

The above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors and/or computers. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Moreover, the image processing apparatus, for example, image processing apparatus 100 shown in FIG. 1, may include at least one processor to execute at least one of the above-described methods.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus comprising:
a view transformer to generate a first view transformation image by transforming a first view color image with a first resolution to a third view, and to generate a second view transformation image by transforming, to the third view, a second view color image with a second resolution higher than the first resolution;
a parameter calculator to calculate a per-pixel weight parameter that is applied to each of the first view transformation image and the second view transformation image; and
an image generator to generate a third view color image corresponding to the third view by applying the calculated per-pixel weight parameter to the first view transformation image and the second view transformation image.

2. The image processing apparatus of claim 1, further comprising:
a high frequency component extractor to extract, in the second view transformation image, an area where a high frequency component is present,
wherein the parameter calculator calculates the per-pixel weight parameter of the extracted area of the second view color image to be higher than other areas.

3. The image processing apparatus of claim 2, wherein the parameter calculator calculates the per-pixel weight parameter of the second view transformation image to be relatively high proportional to a frequency of extracted high frequency component.

4. The image processing apparatus of claim 1, wherein the parameter calculator calculates a first view distance weight parameter that is inversely proportional to a distance between the first view and the third view, and a second view distance weight parameter that is inversely proportional to a distance between the second view and the third view.

5. The image processing apparatus of claim 4, wherein the image generator generates the third view color image by applying the per-pixel weight parameter and the first view distance weight parameter to the first view transformation image, and by applying the per-pixel weight parameter and the second view distance weight parameter to the second view transformation image.

6. The image processing apparatus of claim 2, wherein the parameter calculator applies, to the first view transformation image based on a frequency of the high frequency component, a high pass filter that passes a frequency greater than or equal to a predetermined frequency without attenuation.

7. The image processing apparatus of claim 6, wherein the parameter calculator applies the high pass filter to a pixel of the first transformation image corresponding to a position at which the high frequency component is extracted in the second view transformation image.

8. The image processing apparatus of claim 6, wherein the image generator generates the third view color image by applying the per-pixel weight parameter, a first view distance weight parameter, and the high pass filter to the first view transformation image, and by applying the per-pixel weight parameter and a second view distance weight parameter to the second view transformation image.

9. The image processing apparatus of claim 1, wherein the view transformer generates the first view transformation image and the second view transformation image by performing image warping according to a position of the third view with respect to the first view color image and the second view color image based on depth information of a first view depth image corresponding to the first view color image and depth information of a second view depth image corresponding to the second view color image.

10. The image processing apparatus of claim 1, wherein the image generator generates the third view color image by applying the per-pixel weight parameter to the first view transformation image and the second view transformation image, and by calculating a linear sum for each pixel.

11. The image processing apparatus of claim 1, wherein the third view color image has the second resolution.

12. An image processing method comprising:
generating a first view transformation image by transforming a first view color image with a first resolution to a third view, and generating a second view transformation image by transforming, to the third view, a second view color image with a second resolution higher than the first resolution;
calculating, by a processor, a per-pixel weight parameter that is applied to each of the first view transformation image and the second view transformation image; and
generating a third view color image corresponding to the third view by applying the calculated per-pixel weight parameter to the first view transformation image and the second view transformation image.

13. The image processing method of claim 12, prior to the calculating, further comprising:
extracting, in the second view transformation image, an area where a high frequency component is present,
wherein the calculating comprises calculating the per-pixel weight parameter of the extracted area comprising the high frequency component of the second view color image to be higher than other areas.

14. The image processing method of claim 13, wherein the calculating comprises calculating the per-pixel weight parameter of the second view transformation image to be relatively high proportional to a frequency of extracted high frequency component.

15. The image processing method of claim 12, wherein the calculating comprises calculating a first view distance weight parameter that is inversely proportional to a distance between the first view and the third view, and a second view distance weight parameter that is inversely proportional to a distance between the second view and the third view.

16. The image processing method of claim 15, wherein the generating of the third view color image comprises generating the third view color image by applying the per-pixel weight parameter and the first view distance weight parameter to the first view transformation image, and by applying the per-pixel weight parameter and the second view distance weight parameter to the second view transformation image.

17. The image processing method of claim 13, wherein the calculating comprises applying, to the first view transformation image based on a frequency of the high frequency component, a high pass filter that passes a frequency greater than or equal to a predetermined frequency without attenuation.

18. The image processing method of claim 17, wherein the calculating comprises applying the high pass filter to a pixel of the first transformation image corresponding to a position at which the high frequency component is extracted in the second view transformation image.

19. The image processing method of claim 17, wherein the generating of the third color image comprises generating the third view color image by applying the per-pixel weight parameter, a first view distance weight parameter, and the high pass filter to the first view transformation image, and by applying the per-pixel weight parameter and a second view distance weight parameter to the second view transformation image.

20. The image processing method of claim 12, wherein the generating of the first view transformation image and the second view transformation image comprises generating the first view transformation image and the second view transformation image by performing image warping according to a position of the third view with respect to the first view color image and the second view color image based on depth information of a first view depth image corresponding to the first view color image and depth information of a second view depth image corresponding to the second view color image.

21. The image processing method of claim 12, wherein the generating of the third view color image comprises generating the third view color image by applying the per-pixel weight parameter to the first view transformation image and the second view transformation image, and by calculating a linear sum for each pixel.

22. A non-transitory computer-readable medium comprising a program for instructing a computer to perform the method of claim 12.
